(19) United States
(12) Patent Application Publication
(10) Pub. No.: US 2005/0173893 A1
(43) Pub. Date: Aug. 11, 2005

(54) Pintle mount

(76) Inventors: John T. Buckley, Holland, MI (US); David O. Roe, Grand Haven, MI (US); Brian S. Veldhof, Holland, MI (US); Eric M. Terpsma, Holland, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/519,009

(22) PCT Filed: Jun. 20, 2003
(86) PCT No.: PCT/US03/19631

(30) Foreign Application Priority Data
Jun. 21, 2002 (US) 60390790

(51) Int. Cl. B60D 1/14

(52) U.S. Cl. 280/504

(57) ABSTRACT

A draw bar and universal mount for a trailer hitch comprises a base plate including a first section, a second section and at least two rows of apertures. Furthermore, the draw bar and universal mount includes a shank having a first portion, a second portion and a central portion, the central portion connecting the first portion and the second portion. The shank includes at least one opening and one end disposed on the base plate. The base plate and shank are fabricated from an integral, continuous piece of material.

### BACKGROUND OF THE INVENTION

The present invention generally relates to a trailer hitch mount, and more particularly relates to a pintle hook mount adapted for engagement with a rectangular hitch receiver.

Conventional pintle hooks are used on various towing vehicles, such as trucks and agricultural equipment for hitching the towing vehicle to a trailer. An example of a conventional pintle hook construction is shown in FIGS. 1A and 1B. As shown, the pintle hook includes a main body 12 having an integral base plate 14 and an integral lower jaw hook 16. An upper jaw latch 18 is pivotally attached to body 12 by a pivot pin 20. As shown in FIG. 1B, upper jaw latch 18 may be pivoted upward from its resting position (position A) to position B so as to receive the drawbar eye that would be attached to a trailer. The upper jaw latch 18 would then reassume its resting position, position A, and a locking mechanism 22 would lock upper jaw 18 in position A. As best shown in FIG. 1A, apertures 24 are formed in base plate 14 for attachment to the towing vehicle. Additional details concerning the particular pintle hook shown in FIGS. 1A and 1B are disclosed in commonly assigned U.S. Pat. No. 5,332,250.

While pintle hooks such as those shown in FIGS. 1A and 1B have been attached to larger trucks, agricultural equipment, and other specially manufactured vehicles, it has been proposed to attach such pintle hooks to light trucks, vans, and other vehicles that have a conventional rectangular or square receiver of the type which more commonly would receive a ball mount. Accordingly, pintle mounts such as that shown in FIG. 2 have been constructed to allow pintle hooks to be mounted to vehicles utilizing their conventional receivers. Specifically, the conventional pintle mount includes a shank 30 made of a solid bar having a square or rectangular cross-section with its outer width and height configured to fit within the conventional receiver of smaller vehicles. The shank 30 includes a through-hole 32, which aligns with similar holes in the receiver for receipt of a pin (not shown), which holds the mount in place within the vehicle's receiver. The opposite end of shank 30 from the vehicle is welded or otherwise secured to a base plate 34 having a plurality of apertures 36 formed therein. The apertures 36 may thus be aligned with apertures 24 of a pintle hook and bolts may be inserted therethrough so as to secure the pintle hook on the mount at a height selected by selection of the appropriate apertures 36 in the pintle mount. A gusset 38 may also be welded to both base plate 34 and shank 30 for further mechanical support.

Such pintle mounts as shown, for example, in FIG. 2 are typically limited to 10,000 pounds gross trailer weight (GTW). When the loads exceed the 10,000-pound GTW limit, the base plate 34 begins to deform and the shank 30 begins to bend. Moreover, welds 40 must be very strong to hold the structure firmly together.

One approach to address this concern is to form the mount and pintle hook as a single integral structure. Examples of such constructions are disclosed in U.S. Pat. No. 6,139,043. While such a structure may strengthen the pintle hook assembly as a whole, one loses the flexibility of adjusting the height of the pintle hook on the pintle mount. Additionally, the pintle mount cannot then be utilized for attaching other forms of hitches, such as a ball hitch or the like.

Accordingly, there exists the need for a stronger pintle hook mount that overcomes the problems associated with the prior art pintle mounts while also allowing for the flexibility and variable mounting height provided by such a pintle mount structure.

### SUMMARY OF THE INVENTION

The present invention provides a draw bar and universal mount for a trailer hitch including, a base plate comprising a first section, a second section and at least two rows of apertures. The draw bar and universal mount also includes a shank having a first portion, a second portion and a central portion, wherein the central portion connects the first portion and the second portion. The shank also includes at least one opening and further includes one end disposed on the base plate. Additionally, the base plate and shank are fabricated from an integral, continuous piece of material.

In a second embodiment, the draw bar and universal mount includes a base plate further comprising a first section and a second section and at least two rows of apertures. Further, a shank extends from the base plate and includes at least one opening. Additionally, a first strengthening member connects the first section of the base plate to the first portion of the shank and a second strengthening member connects the second section of the base plate with the second portion of the shank.

A third embodiment includes a base plate further comprising a first section and a second section and at least two rows of apertures. Further, a shank including a first portion, a second portion and a central portion, wherein at least a section of the shank has an I-shaped cross section and the central portion connects the first portion and the second portion in order to form the I-shaped cross section, is provided. Additionally, the shank includes at least one opening and further has one end disposed on the base plate.

In a fourth embodiment, a draw bar mounting assembly for a trailer hitch includes a base plate comprising a first section and a second section and at least two rows of apertures. A shank including a first portion, second portion, and central portion, wherein the central portion connects the first portion and the second portion, is also provided. Additionally, the shank includes at least one opening and one end disposed on the base plate. Further, the base plate and shank are fabricated from a continuous piece of material. A pintle hook configured to be connected to the base plate is also provided wherein the pintle hook can be connected to the base plate using the two rows of apertures.

A fifth embodiment includes a draw bar mounting assembly for a trailer hitch including a base plate comprising a first section and a second section and at least two rows of apertures. A shank is included with at least one opening wherein the shank further includes one end disposed on the base plate. Additionally, a first strengthening member connecting the first section of the base plate to the first portion of the shank and a second strengthening member connecting the second section of the base plate with the second portion of the shank is also provided. Finally, a pintle hook configured to be connected to the base plate is provided, wherein the pintle hook can be connected to the base plate through the two rows of apertures.

Finally, a sixth embodiment is disclosed and includes a base plate comprising a first section and a second section and at least two rows of apertures. Further, a shank including a first portion, second portion, and central portion, wherein the central portion connects the first portion and the second portion is provided. The first and the second portion is at least partially longer in one direction than the central portion in the one direction. Additionally, the shank includes at least one opening and has one disposed on the base plate. A pintle hook is provided and configured to connect to the base plate wherein the pintle hook can be connected to the base plate through the two rows of apertures.

### BRIEF DESCRIPTION OF THE DRAWINGS

In the drawings:

FIG. 1A is a perspective view of a conventional pintle hook;

FIG. 1B is a side view of the conventional pintle hook shown in FIG. 1A;

FIG. 2 is a perspective view of a conventional pintle mount;

FIG. 3A is a plan view showing the top of a pintle hook mount constructed in accordance with a first embodiment of the present invention;

FIG. 3B is a side view of the pintle hook mount shown in FIG. 3A;

FIG. 3C is a front view of the pintle hook mount shown in FIGS. 3A and 3B;

FIG. 3D is a perspective view showing the pintle hook mount shown in FIGS. 3A-3C;

FIG. 4A is a perspective view showing the step of securing the inventive pintle hook mount in a vehicle's receiver;

FIG. 4B is a perspective view showing the second step of securing the inventive pintle hook mount in a vehicle's receiver;

FIG. 4C is a perspective view showing the third step of securing the inventive pintle hook mount in a vehicle's receiver;

FIG. 5A is a perspective view of a pintle hook mount constructed in accordance with a second embodiment of the present invention;

FIG. 5B is a plan view of the top of the pintle mount shown in FIG. 5A;

FIG. 5C is a front view of the pintle mount shown in FIGS. 5A and 5B;

FIG. 5D is a side view of the pintle mount shown in FIGS. 5A-5C;

FIG. 5E is a cross-sectional view of a portion of the pintle mount shown in FIG. 5D taken along line VE-VE;

FIG. 5F is a cross-sectional view of a portion of the pintle mount shown in FIG. 5D taken along line VF-VF.

FIG. 6A is a perspective view of a pintle hook mount constructed in accordance with a third embodiment of the present invention;

FIG. 6B is a plan view of the top of the pintle mount shown in FIG. 6A;

FIG. 6C is a side view of the pintle mount shown in FIGS. 6A and 6B; and

FIG. 6D is a front view of the pintle mount shown in FIGS. 6A-6C.

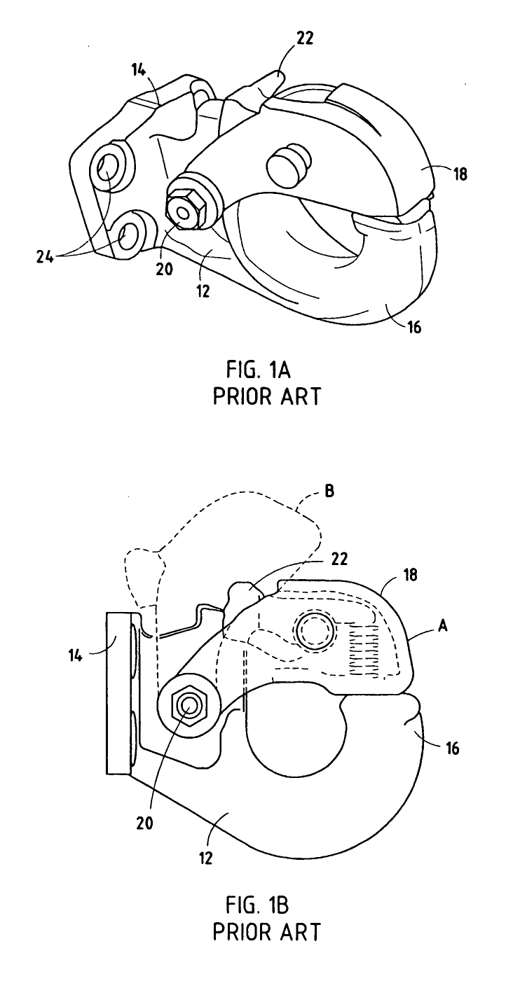

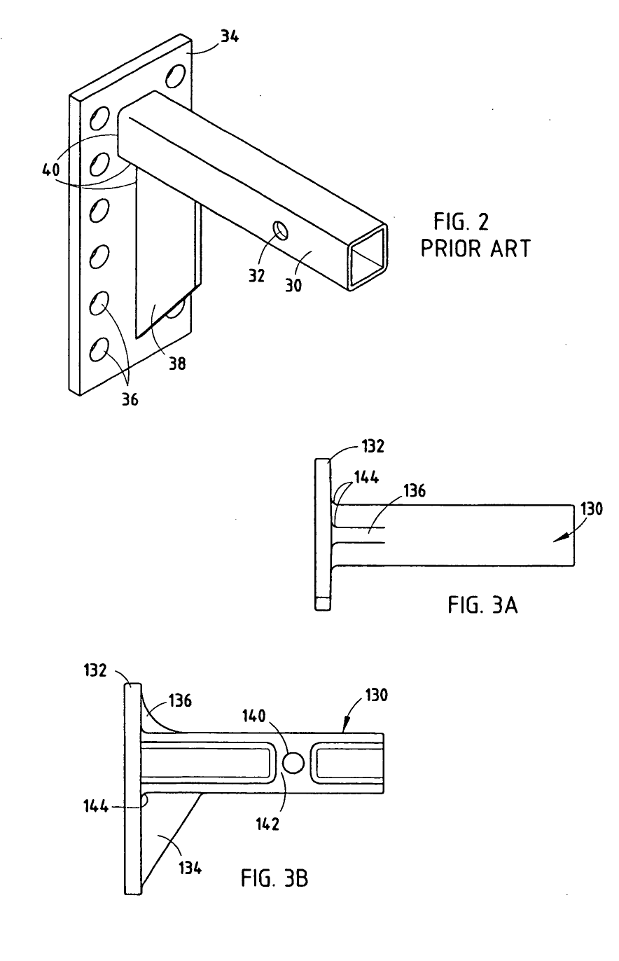

### DETAILED DESCRIPTION OF THE PREFERRED EMBODIMENT

Reference will now be made in detail to the present preferred embodiments of the invention, examples of which are illustrated in the accompanying drawings. Wherever possible, the same reference numerals will be used throughout the drawings to refer to the same or like parts. The dimensions provided in the drawings are included for purposes of example only and are not intended to limit the scope of the present invention.

The pintle mount of the present invention utilizes a one-piece cast design rather than using multiple separate components to form the shank, strengthening member, and base plate, as commonly employed in the prior art pintle mounts. Thus, the weakness provided by the welds 40 is eliminated. In addition, because of the added strength, the construction is generally more compact, lighter in weight, and less costly than the prior art products.

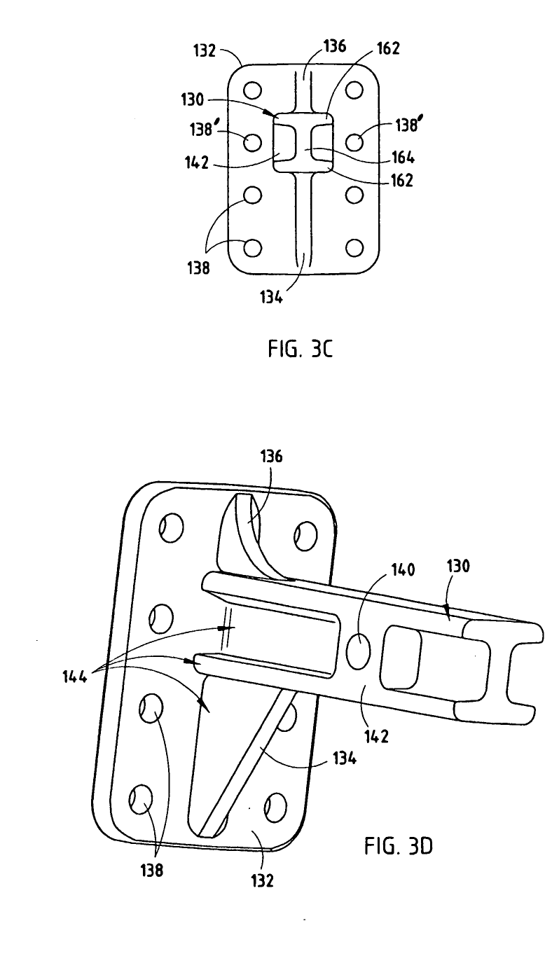

As illustrated in FIGS. 3A-3D, the first embodiment of the pintle mount of the present invention is shown and comprises a shank 130 in the form of an I-beam, a base plate 132, and a second strengthening member 134 all integrally formed as a one-piece casting. Second strengthening member 134 advantageously is molded in and integrally formed with shank 130 and base plate 132 so as to gently transfer the loads to the shank without causing any stress risers in shank 130. An optional first strengthening member 136 may also be integrally formed to extend from the top of the I-beam shank 130 to the upper portion of base plate 132. By providing first strengthening member 136, the upper portion of base mounting plate 132 is more strongly supported and secured to shank 130.

Base plate 132 preferably has a plurality of apertures 138 (FIG. 3C) formed therethrough for securing a pintle hook or other form of hitch. Preferably, at least two rows of apertures are disposed longitudinally on base plate 132. Further, by positioning at least one pair 138′ of apertures 138 in base plate 132 so as to straddle opposite sides of I-beam shank 130, the installation of washers and nuts on the mounting bolts that fit through holes 138′ may be improved.

Shank 130 preferably includes a first portion 160, a second portion 162, and a central portion 164 (FIG. 3C). The first portion 160 and the second portion 162 are equal in length in a direction which is perpendicular to central portion 164 to form an I-beam-type of construction. By shaping the I-beam shank 130 so as to have the I-beam-type construction, the strength of shank 130 may be maximized while allowing it to be easily manufactured and installed into the receiver by the user. Additionally, the weight of the shank relative to a solid construction is significantly decreased.

To facilitate the provision of a through-hole 140 in shank 130, the portion of shank 130 in the vicinity of through-hole 140 is preferably formed to have a rectangular or square cross-section serving as a crossover gusset 142 that provides sufficient strength to that portion of the shank 130. This crossover gusset 142 additionally improves the strength and rigidity of the shank 130 as a whole.

As shown in FIG. 3D, the interface 144 between first strengthening member 136, second strengthening member 134, base plate 132, and shank 130 is preferably radiused. The size and shape of the radius 144 that is used to connect the I-beam shank 130 to mounting surface 132 provides maximum strength and minimum interference with mounting hardware.

In addition to providing a radiused interface 144 between the strengthening members, shank, and base plate, other corners and edges of the pintle mount may also be radiused so as to prevent injury to the operator.

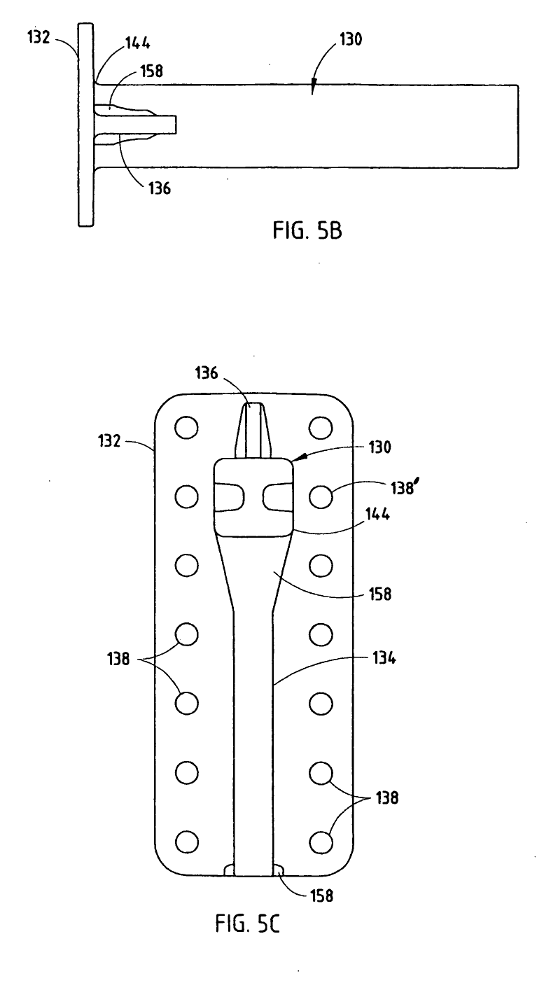

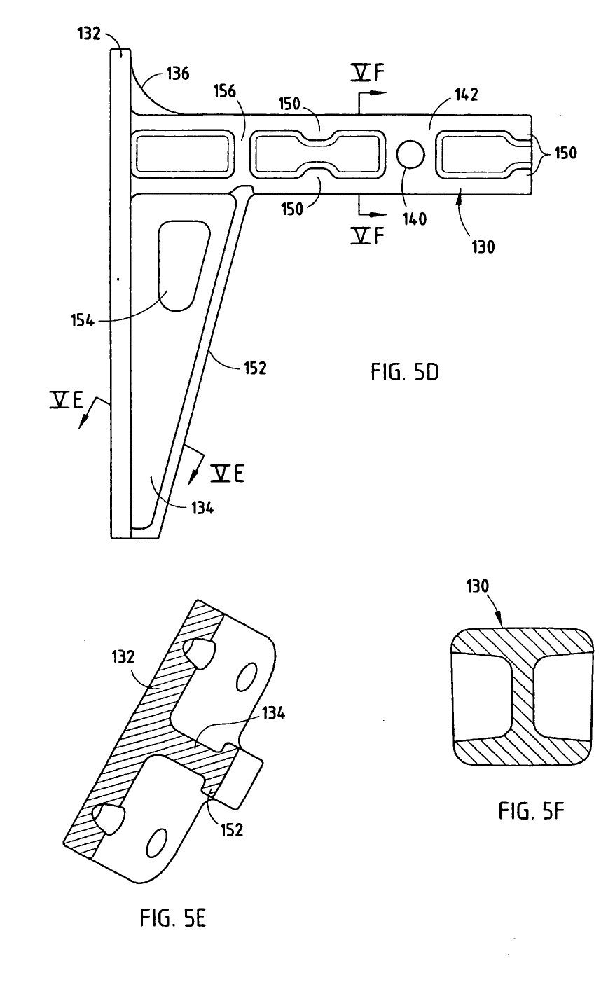

A second embodiment is shown in FIGS. 5A-5F and includes one or more strengthening bumps 150 which may be provided in the I-beam shank 130 to increase its overall strength.

As shown in FIGS. 5A, 5D, and 5E, second strengthening member 134 may be configured to have a wider rim or edge 152 that provides a cross-sectional T-shape. This allows the lower gusset 134 to be made somewhat thinner and thus the weight of the pintle mount is decreased while the strength is maintained or increased by the presence of rim 152. Additionally, a hole 154 may be provided through second strengthening member 134 to further decrease the weight without sacrificing its strength. Second strengthening member 134 and optionally first strengthening member 136 may also be flared so as to have an increased width at its upper and lower extent where it joins shank 130 and base plate 132. These flares 158 may be provided throughout the thickness of the gusset or may be provided just in the portion of rim 152. The flares improve the strength performance of the pintle mount while also reducing stresses due to heavy loads.

Another feature that may be implemented to increase the strength of the pintle mount is to provide a second crossover gusset 156 within the I-beam shank 130. Preferably, as shown in FIGS. 5A and 5D, crossover gusset 156 is provided in the location of shank 130 where it interfaces with rim 152 of second strengthening member 134. This second crossover gusset 156 maintains the strength of the pintle hook while allowing the weight of the shank to be reduced through the utilization of the I-beam construction.

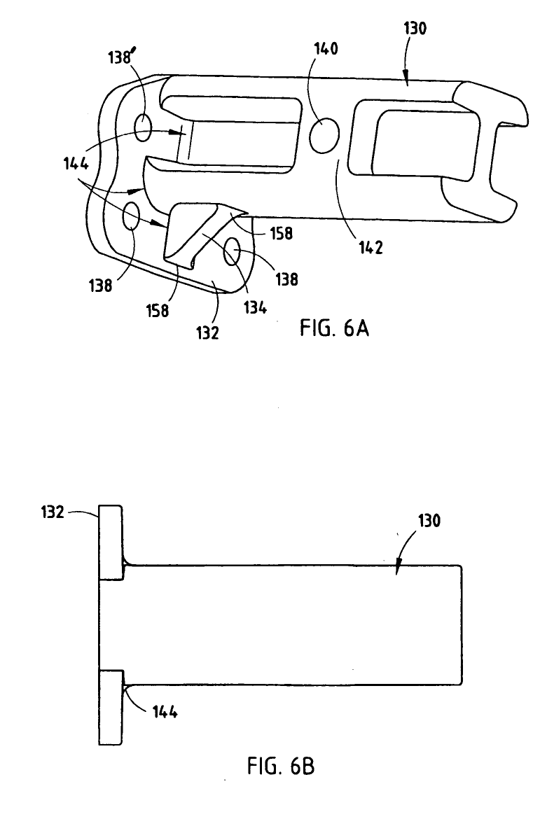

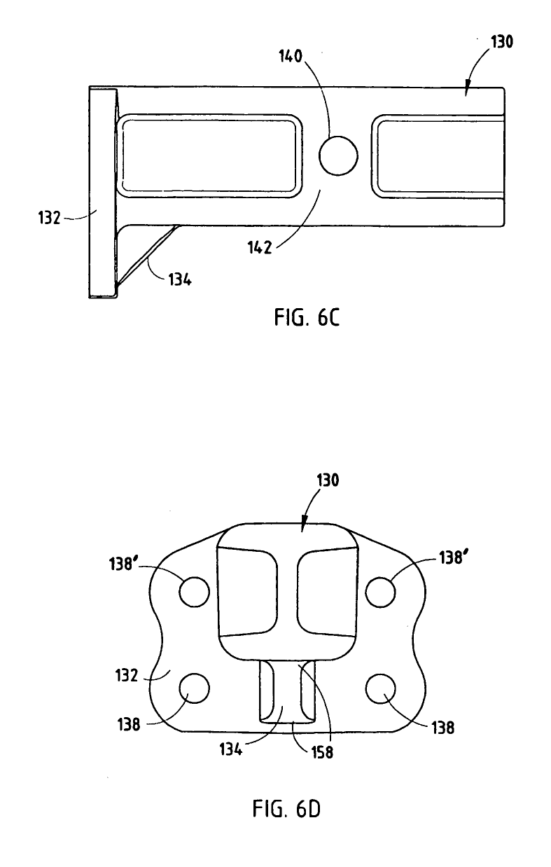

While the base plate 132 shown in the first and second embodiments is generally rectangular, base plate 132 may have a different shape as utilized in the third embodiment shown in FIGS. 6A-6D. The shape of base plate 132 may be selected so as to reduce the weight of the pintle mount while maintaining its overall strength. Thus, base plate 132 may have a non-rectangular or, more specifically, a curved shape.

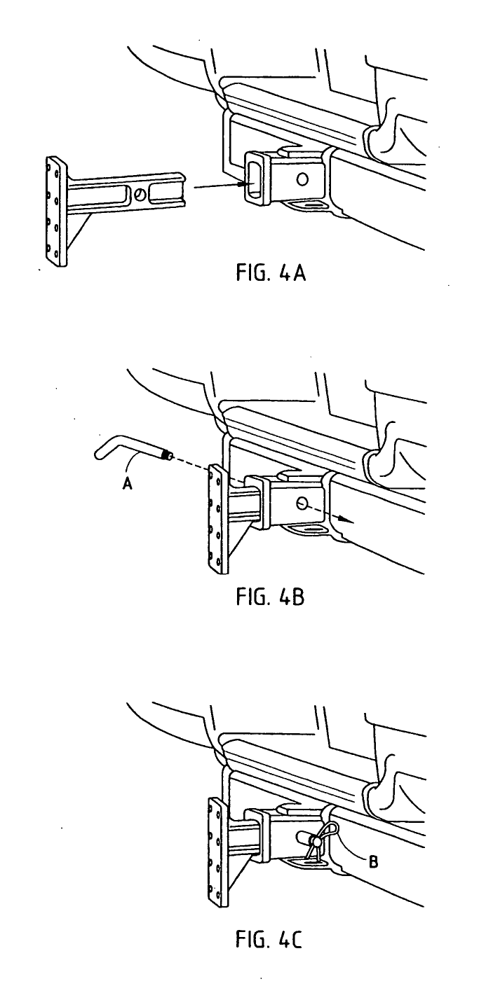

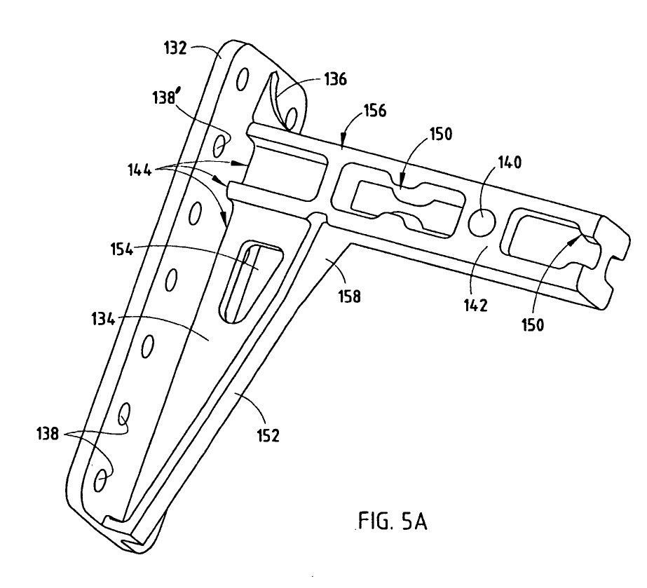

FIG. 4A shows the first step of mounting the draw bar and universal mount in a receiver that is attached to the bumper or chassis of the towing vehicle. In this first step, the shank or draw bar of the pintle mount is slid into the receiver to such a depth that the through-hole on the shank aligns with a through-hole on the receiver. Then, as shown in FIG. 4B, a pin A is slid through the aligned through-holes. A spring clip B is then passed through a hole at the end of pin A so as to prevent pin A from becoming dislodged (see FIG. 4C). The pintle hook may then be mounted to the universal mounting base plate. Alternatively, the pintle hook may be secured to the pintle mount prior to the preceding steps. Furthermore, a variety of hitching mechanisms such as, for example, a ball-style receiver may alternatively be attached to the universal mounting base plate. Further, any type of current or future receiving mechanism may be affixed to the draw bar and universal mount and the invention is not meant to be limited to pintle hooks.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. A draw bar and universal mount for a trailer hitch comprising:
a base plate including a first section, a second section and at least two rows of apertures; and
a shank including a first portion, a second portion and a central portion, the central portion connecting the first portion and the second portion, the shank including at least one opening, the shank further including one end disposed on the base plate;
wherein the base plate and shank are fabricated from an integral, continuous piece of material.

2. The draw bar and universal mount according to claim 1, further including:
a first strengthening member connecting the first section of the base plate to the first portion of the shank.

3. The draw bar and universal mount according to claim 2, wherein:
the first strengthening member includes a first central area and a first outer edge; and
the first outer edge extends beyond the central area forming a first T-shaped cross section with the first central area.

4. The draw bar and universal mount according to claim 3, further including:
a second strengthening member connecting the second section of the base plate to the second portion of the shank.

5. The draw bar and universal mount according to claim 4, wherein:
the second strengthening member includes a second central area and a second outer edge;
the second outer edge extends beyond the second central area forming a second T-shaped cross section with the central area.

6. The draw bar and universal mount according to claim 5, wherein:
the second strengthening member includes an opening within the second central area.

7. The draw bar and universal mount according to claim 6, wherein:
a segment of the second outer edge of the second strengthening member extends progressively further away from the second central area as the outer edge approaches at least one of the second portion of the shank and the base plate.

8. (canceled)

9. The draw bar and universal mount according to claim 1, wherein:
the first portion, the second portion and the central portion at least partially form an I-shaped cross section.

10. The draw bar and universal mount according to claim 9, wherein:
the first portion, the second portion and the central portion of the shank at least partially form a rectangular like cross section.

11. The draw bar and universal mount according to claim 10, wherein:
the at least one opening extends through the rectangular cross section.

12. (canceled)

13. The draw bar and universal mount according to claim 1, wherein:
at least one aperture from each of the at least two rows of apertures is disposed on the base plate between the first portion and the second portion of the shank.

14. The draw bar and universal mount according to claim 1, wherein:
each of the first section and the second section of the base plate further include at least two corners; and
each of the at least two corners are radiused.

15. The draw bar and universal mount according to claim 14, wherein:
the first section and the second section meet at an arcuate intersection.

16. The draw bar and universal mount according to claim 15 including:
a strengthening member connecting the second section of the base plate with the second portion of the shank.

17. The draw bar and universal mount according to claim 16, wherein:
the base plate, the shank and the strengthening member are fabricated from an integral, continuous piece of material.

18. The draw bar and universal mount according to claim 1, wherein:
the first portion, the second portion and the central portion at least partially form an I-shaped cross section.

19. The draw bar and universal mount according to claim 18, wherein:
the at least two rows of apertures are longitudinally disposed along the longest dimension of the base plate.

20. The draw bar and universal mount according to claim 19, wherein:
at least one aperture from each of the at least two rows of apertures is disposed on the base plate between the first portion and the second portion of the shank.

21. The draw bar and universal mount according to claim 20, wherein:
the first portion, the second portion and the central portion of the shank at least partially form a square-like cross section.

22. The draw bar and universal mount according to claim 21, wherein:
the at least one opening is disposed on the shank at the position where the first portion, the second portion and the central portion of the shank at least partially form a square-like cross section.

23. A draw bar and universal mount for a trailer hitch comprising:
a base plate including a first section and a second section and at least two rows of apertures;
a shank extending from the base plate, the shank including at least one opening;
a first strengthening member connecting the first section of the base plate to the first portion of the shank; and
a second strengthening member connecting the second section of the base plate with the second portion of the shank.

24. (canceled)

25. The draw bar and universal mount according to claim 23, wherein:
the base plate, shank, first strengthening member and second strengthening member are fabricated from an integral, continuous piece of material.

26. (canceled)

27. The draw bar and universal mount according to claim 23, wherein:
the first strengthening member includes a central area and an outer edge; and
the outer edge extending beyond the central area and forming a T-shaped cross section with the central area.

28. The draw bar and universal mount according to claim 23, wherein:
the second strengthening member includes a central area and an outer edge; and
the outer edge extending beyond the central area forming a T-shaped cross section with the central area.

29. The draw bar and universal mount according to claim 28, wherein:
the second strengthening member includes an opening within the central area.

30. The draw bar and universal mount according to claim 29, wherein:
the outer edge of the second strengthening member further extends beyond the central area as the outer edge approaches at least one of the second portion of the shank and the base plate.

31. The draw bar and universal mount to claim 23, wherein:
the base plate, the shank, the first strengthening member and the second strengthening member are fabricated from an integral, continuous piece of material.

32. (canceled)

33. The draw bar and universal mount according to claim 31, wherein:
the first strengthening member includes a central area and an outer edge; and
the outer edge extending beyond the central area and forming a T-shaped cross section with the central area.

34. The draw bar and universal mount according to claim 33, wherein:
the second strengthening member includes a central area and an outer edge; and
the outer edge extending beyond the central area and forming a T-shaped cross section with the central area.

35. The draw bar and universal mount according to claim 34, wherein:
the second strengthening member includes an opening within the central area.

36. The draw bar and universal mount according to claim 35, wherein:
the outer edge of the second strengthening member further extends beyond the central area as the outer edge approaches at least one of the second portion of the shank and the base plate.

37. A draw bar and universal mount for a trailer hitch comprising:
a base plate including a first section and a second section and at least two rows of apertures; and
a shank including one end disposed on the base plate, the shank further including a first portion, a second portion and a central portion, at least a section of the shank having an I-shaped cross section, with the central portion connecting the first portion and the second portion to form the I-shaped cross section, the shank including at least one opening.

38. The draw bar and universal mount according to claim 37, wherein:
the base plate and shank are fabricated from an integral, continuous piece of material.

39. The draw bar and universal mount according to claim 37, further including:
a first strengthening member connecting the first section of the base plate to the first portion of the shank.

40. The draw bar and universal mount according to claim 39, wherein:
the first strengthening member includes a central area and an outer edge; and
the outer edge extending beyond the central area and forming a T-shaped cross section with the central area.

41. The draw bar and universal mount according to claim 40, further including:
a second strengthening member connecting the second section of the base plate to the second portion of the shank.

42. The draw bar and universal mount according to claim 41, wherein:
the second strengthening member includes a central area and an outer edge;
the outer edge extending beyond the central area and forming a T-shaped cross section with the central area.

43. The draw bar and universal mount according to claim 42, wherein:
the second strengthening member includes an opening within the central area.

44. The draw bar and universal mount according to claim 43, wherein:
the outer edge of the second strengthening member further extends beyond the central area as the outer edge approaches at least one of the second portion of the shank and the base plate.

45. (canceled)

46. The draw bar and universal mount according to claim 37, wherein:
the first portion, the second portion and the central portion at least partially form an I-shaped cross section.

47. (canceled)

48. (canceled)

49. The draw bar and universal mount according to claim 37, wherein:
the first portion, the second portion and the central portion of the shank at least partially form a square-like cross section.

50. The draw bar and universal mount according to claim 49, wherein:
the at least one opening is disposed on the shank at the position where the first portion, the second portion and the central portion of the shank at least partially form a square-like cross section.

51. (canceled)

52. (canceled)

53. The draw bar and universal mount according to claim 37 including:
a strengthening member connecting the second section of the base plate with the second portion of the shank.

54. The draw bar and universal mount according to claim 53, wherein:
the base plate, the shank and the strengthening member are fabricated from an integral, continuous piece of material.

55. The draw bar and universal mount according to claim 37, wherein:
the first portion, the second portion and the central portion at least partially form an I-shaped cross section.

56-59. (canceled)

60. A draw bar mounting assembly for a trailer hitch comprising:
a base plate including a first section and a second section and at least two rows of apertures;
a shank including a first portion, second portion, and central portion, the central portion connecting the first portion and the second portion, the shank including at least one opening, wherein the shank further includes one end disposed on the base plate, and wherein further the base plate and shank are fabricated from a continuous piece of material; and
a pintle hook configured to be connected to the base plate;
wherein the pintle hook can be connected to the base plate using the at least two rows of apertures.

61. The draw bar and universal mount according to claim 60, further including:
a first strengthening member connecting the first section of the base plate to the first portion of the shank.

62. The draw bar and universal mount according to claim 61, wherein:
the first strengthening member includes a central area and an outer edge; and
the outer edge extending beyond the central area and forming a T-shaped cross section with the central area.

63. The draw bar and universal mount according to claim 62, further including:
a second strengthening member connecting the second section of the base plate to the second portion of the shank.

64. The draw bar and universal mount according to claim 63, wherein:
the second strengthening member includes a central area and an outer edge;
the outer edge extending beyond the central area and forming a T-shaped cross section with the central area.

65. The draw bar and universal mount according to claim 64, wherein:
the second strengthening member includes an opening within the central area.

66. The draw bar and universal mount according to claim 65, wherein:
the outer edge of the second strengthening member further extends beyond the central area as the outer edge approaches at least one of the second portion of the shank and the base plate.

67. (canceled)

68. The draw bar and universal mount according to claim 60, wherein:
the first portion, the second portion and the central portion at least partially form an I-shaped cross section.

69. The draw bar and universal mount according to claim 68, wherein:
the first portion, the second portion and the central portion of the shank at least partially form a square-like cross section.

70-72. (canceled)

73. The draw bar and universal mount according to claim 60, wherein:
the first portion, the second portion and the central portion at least partially form an I-shaped cross section.

74. (canceled)

75. (canceled)

76. The draw bar and universal mount according to claim 73, wherein:
the first portion, the second portion and the central portion of the shank at least partially form a square-like cross section.

77. (canceled)

78. A draw bar mounting assembly for a trailer hitch comprising:
a base plate including a first section and a second section and at least two rows of apertures;
a shank including at least one opening, wherein the shank further includes one end disposed on the base plate;
a first strengthening member connecting the first section of the base plate to the first portion of the shank;
a second strengthening member connecting the second section of the base plate with the second portion of the shank; and
a pintle hook configured to be connected to the base plate;
wherein the pintle hook can be connected to the base plate through the at least two rows of apertures.

79. (canceled)

80. The draw bar and universal mount according to claim 78, wherein:
the base plate, shank, first strengthening member and second strengthening member are fabricated from an integral, continuous piece of material.

81. (canceled)

82. The draw bar and universal mount according to claim 78, wherein:
the first strengthening member includes a central area and an outer edge; and
the outer edge extending beyond the central area and forming a T-shaped cross section with the central area.

83. The draw bar and universal mount according to claim 78, wherein:
the second strengthening member includes a central area and an outer edge;
the outer edge extending beyond the central area and forming a T-shaped cross section with the central area.

84. The draw bar and universal mount according to claim 83, wherein:
the second strengthening member includes an opening within the central area.

85. The draw bar and universal mount according to claim 84, wherein:
the outer edge of the second strengthening member further extends beyond the central area as the outer edge approaches at least one of the second portion of the shank and the base plate.

86. The draw bar and universal mount according to claim 78, wherein:
the base plate, shank, first strengthening member and second strengthening member are fabricated from an integral, continuous piece of material.

87. (canceled)

88. The draw bar and universal mount according to claim 86, wherein:
the first strengthening member includes a central area and an outer edge; and
the outer edge extending beyond the central area forming a T-shaped cross section with the central area.

89. The draw bar and universal mount according to claim 88, wherein:
the second strengthening member includes a central portion and an outer edge;
the outer edge extending beyond the central area forming a T-shaped cross section with the central area.

90. The draw bar and universal mount according to claim 89, wherein:
the second strengthening member includes an opening within the central area.

91. The draw bar and universal mount according to claim 90, wherein:
the outer edge of the second strengthening member further extends beyond the central area as the outer edge approaches at least one of the second portion of the shank and the base plate.

92. A draw bar mounting assembly for a trailer hitch comprising:
a base plate including a first section and a second section and at least two rows of apertures;
a shank including a first portion, second portion, and central portion, the central portion connecting the first portion and the second portion, the first portion and the second portion being at least partially longer in one direction than the central portion in the one direction, the shank including at least one opening, wherein the shank further includes one end disposed on the base plate; and
a pintle hook configured to be connected to the base plate;
wherein the pintle hook can be connected to the base plate through the at least two rows of apertures.

93. The draw bar and universal mount according to claim 92, where the base plate and shank are fabricated from an integral, continuous piece of material.

94. The draw bar and universal mount according to claim 92, further including:
a first strengthening member connecting the first section of the base plate to the first portion of the shank.

95. The draw bar and universal mount according to claim 94, wherein:
the first strengthening member includes a central area and an outer edge; and
the outer edge extending beyond the central area and forming a T-shaped cross section with the central area.

96. The draw bar and universal mount to claim 95, further including:
a second strengthening member connecting the second section of the base plate to the second portion of the shank.

97. The draw bar and universal mount according to claim 96, wherein:
the second strengthening member includes a central area and an outer edge;
the outer edge extending beyond the central area and forming a T-shaped cross section with the central area.

98. The draw bar and universal mount according to claim 97, wherein:
the second strengthening member includes an opening within the central area.

99. The draw bar and universal mount according to claim 98, wherein:
the outer edge of the second strengthening member further extends beyond the central area as the outer edge approaches at least one of the second portion of the shank and the base plate.

100. (canceled)

101. The draw bar and universal mount according to claim 92, wherein:
the first portion, the second portion and the central portion at least partially form an I-shaped cross section.

102. The draw bar and universal mount according to claim 101, wherein:
the first portion, the second portion and the central portion of the shank at least partially form a square-like cross section.

103. The draw bar and universal mount according to claim 102, wherein:
the at least one opening is disposed on the shank at the position where the first portion, the second portion and the central portion of the shank at least partially form a square-like cross section.

104-110. (canceled)
